(19) United States
(12) Patent Application Publication
(10) Pub. No.: US 2010/0248793 A1
(43) Pub. Date: Sep. 30, 2010

(54) METHOD AND APPARATUS FOR LOW COST HANDSET WITH VOICE CONTROL

(75) Inventors: Robert Czajkowski, Carlsbad, CA (US); Owens F. Alexander, JR., Rancho Santa Fe, CA (US)

Correspondence Address: PROCOPIO, CORY, HARGREAVES & SAVITCH LLP, 525 B STREET, SUITE 2200, SAN DIEGO, CA, 92101, US

(73) Assignee: REAL PHONE CARD CORPORATION, San Diego, CA (US)

(21) Appl. No.: 12/751,655

(22) Filed: Mar. 31, 2010

Related U.S. Application Data
(60) Provisional application No. 61/165,400, filed on Mar. 31, 2009.

(51) Int. Cl. H04W 4/00; G10L 15/00

(52) U.S. Cl. 455/569.1; 704/246

(57) ABSTRACT

Systems, methods and apparatuses for a unique wireless handset are described. One embodiment may be directed to a wireless handset that uses voice recognition to simplify the operation of the handset and therefore allows the handset to include fewer input keys. Using speaker dependent voice recognition (VR) software, the recognition rates for most users can exceed 95%. The reliability of the speaker dependent voice recognition used in the embodiment, allows for a design that eliminates the traditional keypad and creates a large space on the face of the handset for prominent corporate or institutional logos and images. This form factor provides an excellent platform for branding and marketing promotional applications.

### RELATED APPLICATION

The present application claims priority to U.S. provisional patent application Ser. No. 61/165,400 filed Mar. 31, 2009, which is incorporated herein by reference in its entirety.

### BACKGROUND

1. Field of Invention

The present invention relates to low cost handsets that employ voice control, more particularly the invention relates to handsets having middleware software, or modules, that couple a voice recognition engine to the handset operating system and provides for voice operation of the handset.

2. Related Art

Technological improvements in recent years have produced the Smart phone category of handsets with advanced features such as cameras, web access, email, and thousands of special user applications. The same improvements in technology and cost reduction have produced the ultra low cost entry level category of handsets with numerous devices priced for the rapidly growing customer base in developing areas, such as, China, India, Africa, and South America. Furthermore, corporations are aggressively exploring ways to use mobile marketing initiatives to expand their markets, extend their brands, and increase revenues.

As a result of this innovation, mobile phones have become one of the most ubiquitous devices in our culture. With almost 5 billion wireless connections worldwide and new handsets being delivered at a rate of over 1 billion per year there are few industries as robust. However, mobile users are seldom without their mobile handsets, even though the handsets they have may not be appropriate for the particular activity they are undertaking.

### SUMMARY

The present invention provides a unique solution to both the desire of corporations and institutions to participate in mobile marketing; and for individuals to have a mobile device that is designed specifically for special uses. Particularly, the present invention relates to a thin, light, and durable mobile handset that includes embedded voice recognition software for simple, efficient operation. As such, the invention may combine a unique collection of advanced technologies brought together to result in a low cost, easy to use configuration.

Embodiments of the present invention may include mobile handsets incorporating speaker dependent voice recognition (VR) software with recognition rates for most users of over 95%. This is compared with the 80% recognition rates of the standard independent voice recognition used on common high end mobile phones. Benefits offered by speaker dependent voice recognition include the ability to eliminate the traditional keypad and create a large space on the face of the handset for prominent corporate or institutional logos and images. This form factor provides an excellent platform for branding and marketing promotional applications.

The embodiments may include a mobile handset incorporating a middleware component, software, or module that connects the voice recognition engine to the Infineon operating system and provides for the operation of the handset. The implementation is done in a manner which minimizes user voice commands. Training time is short (less than 1 minute), yet voice recognition (VR) accuracy exceeds the accuracy rate of handsets utilizing speaker independent voice recognition technology. Once an activated SIM card is inserted, the mobile device may be ready to initialize and use by pressing a key and issuing simple verbal commands. Systems, methods and apparatusses for a wireless handset are described. In one embodiment, a wireless handset includes a chipset that includes a controller and radio frequency electronics. VR software is ported to the controller. The wireless handset also includes a microphone, a receiver, and an input key. The input key cooperates with the VR software to activate a set of functions of the handset. There is also a display that provides visual information to a user.

The handset may also include memory software. In addition, the input key and the VR software may cooperate to receive a handset number from a user. The VR software may be configured for a language in accordance with where the handset is intended to be used. In one embodiment, the VR software includes software that controls the operation of the control chip.

In one embodiment, the handset is configured to communicate with a code division multiple access (CDMA) network. In another embodiment, the handset is configured to communicate with a global system for mobile communications (GSM) network.

In one embodiment, a method of making a handset includes porting VR software to a controller in a chipset, the chipset including the controller and radio frequency electronics. The chipset, a microphone, a receiver, a display, and an input key are installed into a body, wherein the body includes opening for the microphone, receiver, display, and input key, wherein the input key is configured to operate with the VR software to activate a set of functions of the handset.

In yet another embodiment, a method of controlling a wireless handset includes porting VR software to a controller, providing a simplified user interface for controlling the handset, the user interface including a user input key and a set of voice commands that are used to change the configuration of the handset. The method may further include providing radio frequency electronics that interface with the controller and transmit and receive radio signals with a cellular base station.

In still another embodiment, a wireless handset may include the following: a chipset having a controller and radio frequency electronics, VR software that is ported to the controller, a microphone, a receiver, an input key that cooperates with the VR software to activate a set of functions of the handset, and a display that provides visual information.

In one embodiment, the handset may include a unique collection of advanced technologies brought together to result in a low cost, easy to use mobile phone configuration with many unique attributes not found in other cellular products. In one example, it is light weight at 1.3 ounces, thin at 5.9 mm, highly water resistant and very durable. Another embodiment may be about the size of a credit card, making it very easy to carry or wear.

Another advantage of speaker dependent VR is language independence. As long as the user can read the instructions on the screen and/or understand the prompt languages offered, the user can record his/her voice for the commands, digits, and symbols in any language. These responses will again be converted to spectral data and stored. Then, when the user speaks a command, digit or symbol, the processor/software will look for a match and respond accordingly.

Once an active SIM card is inserted into the GSM version, the mobile phone is ready to initialize and use by pressing a few keys and issuing verbal commands.

Other features and advantages of the present invention should be apparent after reviewing the following detailed description and accompanying drawings which illustrate, by way of example, aspects of the invention.

### BRIEF DESCRIPTION OF THE DRAWINGS

These and other aspects, advantages and details of the present invention, both as to its structure and operation, may be gleaned in part by a study of the accompanying exemplary drawings, in which like reference numerals refer to like parts. The drawings are not necessarily to scale, emphasis instead being placed upon illustrating the principles of the invention.

FIG. 1 is a block diagram of an embodiment of a wireless cellular communication system.

FIG. 2 is a block diagram of a front view of an embodiment of a cellular or wireless handset that can be used in the cellular communication system of FIG. 1.

FIG. 3 is a block diagram of a side view of the handset 100 of FIG. 2.

FIG. 4 shows front, rear and four side views of one embodiment having: an OK key; two scroll keys; two soft keys; the Power ON/OFF key; and the Send/Receive key.

FIG. 5 is a collection of sample screen images which may be displayed in the display of the device to implement various functions.

FIG. 6 is a block diagram of the relationship between the software packages: Nuance Voice Tag; Infineon Operating System and Real Phone Card Middleware.

FIG. 7 is a diagram illustrating the virtual keypad.

### DETAILED DESCRIPTION

Certain embodiments as disclosed herein provide for methods and systems for communication over a wireless network. After reading this description it will become apparent how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

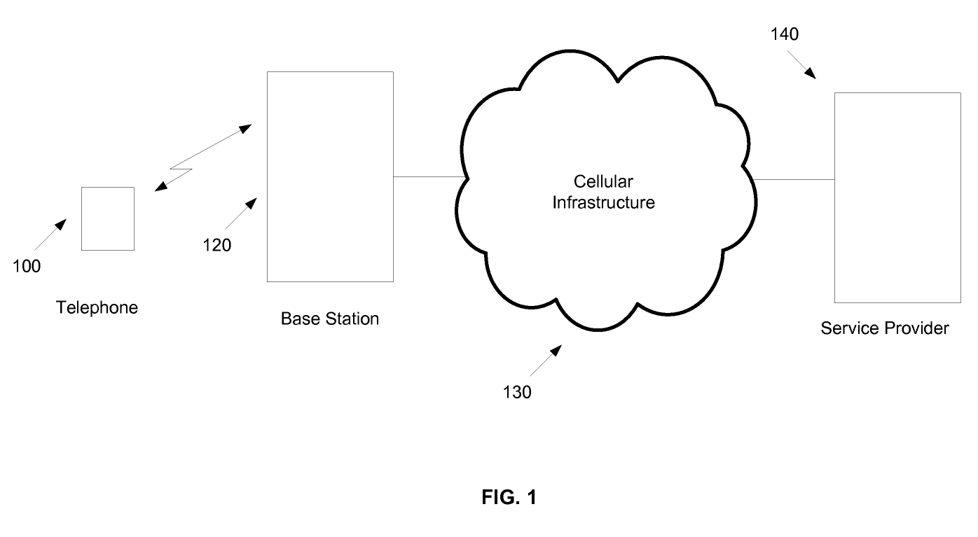

A cellular handset is provided that is convenient to use, of small dimension, and sufficiently inexpensive to manufacture. FIG. 1 is a block diagram of an embodiment of a wireless cellular communication system. In the example of FIG. 1, a cellular handset 100, is in communication with a base station 120.

In one embodiment, data is transmitted between the cellular handset 100 and the base station 120 to facilitate voice communications. In other embodiments, data transmitted between the cellular handset 100 and the base station 120 may support other types of communications.

The communication between the cellular handset 100 and the base station 120 may be based on code division multiple access (CDMA) techniques. Alternatively, the communication between the cellular handset 100 and the base station 120 may be based on Global System for Mobile communication (GSM) techniques. In other embodiments, the communication between the cellular handset 100 and the base station 120 may be based on Worldwide Interoperability for Microwave Access (WiMAX) standards (i.e., the Institute for Electrical and Electronics Engineers (IEEE) 802.16 Standards), Wi-Fi (i.e., the Institute for Electrical and Electronics Engineers (IEEE) 802.11 Standards), or other wireless techniques.

As shown in FIG. 1, the base station 120 is also in communication with a cellular infrastructure 130. The cellular infrastructure 130 may include one or more networks and one or more service providers 140 (e.g., carriers). For example, the cellular infrastructure 130 may include the Public Switched Handset Network (PSTN), Wide Area Networks (WAN), such as the Internet, and other wired and wireless networks. Other entities may also be in communication with the cellular infrastructure 130 are other entities.

While the embodiment of FIG. 1 shows only one cellular handset 100 in communication with the base station 120, in other embodiments there may be a plurality of cellular handsets 100 in communication with the base station 120. In addition there may be a plurality of base stations 120. Furthermore, there may be a plurality of other entities in communication with the cellular infrastructure 130.

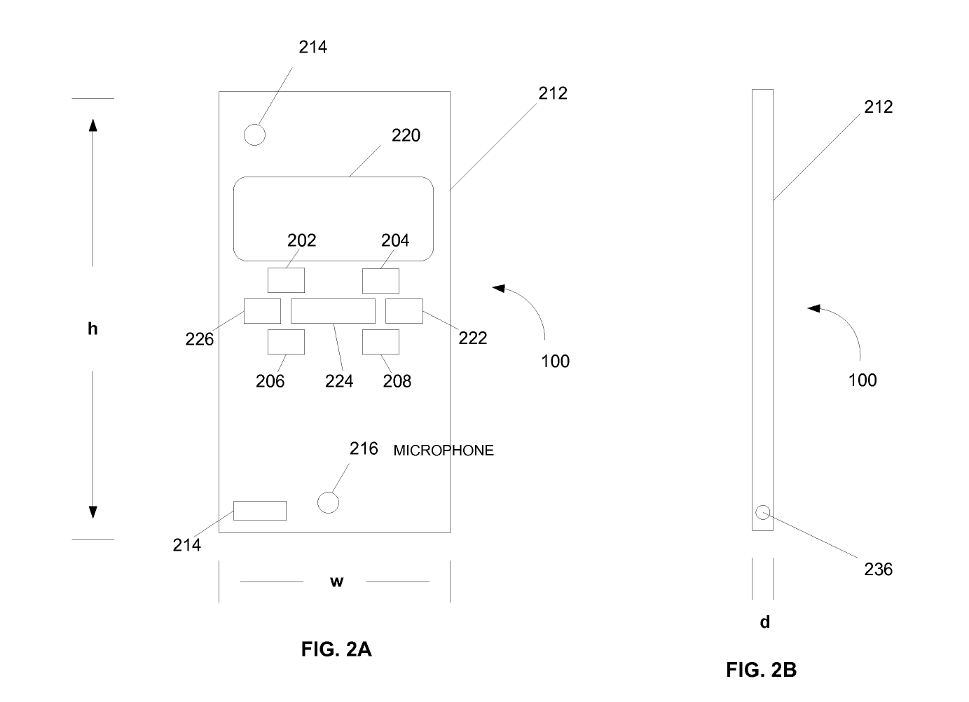

FIG. 2 is a diagram of a front view of an embodiment of a cellular or wireless handset that may be used in the cellular communication system of FIG. 1. An example of an embodiment of a cellular or wireless handset that may be used in conjunction with the present invention is described in U.S. patent application Ser. No. 11/940,247, which is incorporated by reference in its entirety. As shown in the example of FIG. 2, the handset 100 includes a handset body 212, which encloses a control chip and other chips, referred to as a chipset (not shown) including radio frequency electronics, digital electronics, firmware and optional memory (not shown). The chipset may be adapted to radiate and receive radio frequency signals to and from wireless base stations via an antenna. The chipset may also provide VR and voice activated control of the handset. In one embodiment, VR software, ormodule, is ported to the control chip. For example, the VR software may include software, or firmware, or both, that controls operation of the control chip to implement VR functions. In another example, the VR software may include software, or firmware, or both that are installed into memory software and the control chip accesses the memory software to implement VR functions. In still another example, the VR software may include hardware that cooperates with the control chip to implement VR functions. In one embodiment, porting the VR software to the control chip includes interfacing the control software to the control chip. A benefit of the handset 100 is that using VR can simplify the operation of the handset 100 and help to reduce the size of the handset 100 by reducing or eliminating a number of keys in a keypad or keyboard of the handset. In one embodiment, the handset body 212 has a passage through which a microphone 216 may receive an analog voice signal. The voice signal is delivered to the chipset, or digital electronics via the microphone 216. The body 212 may also have a passage through which a receiver 214 may receive analog electric signals and produce sound waves by transmitting an analog voice or voice prompt signal.

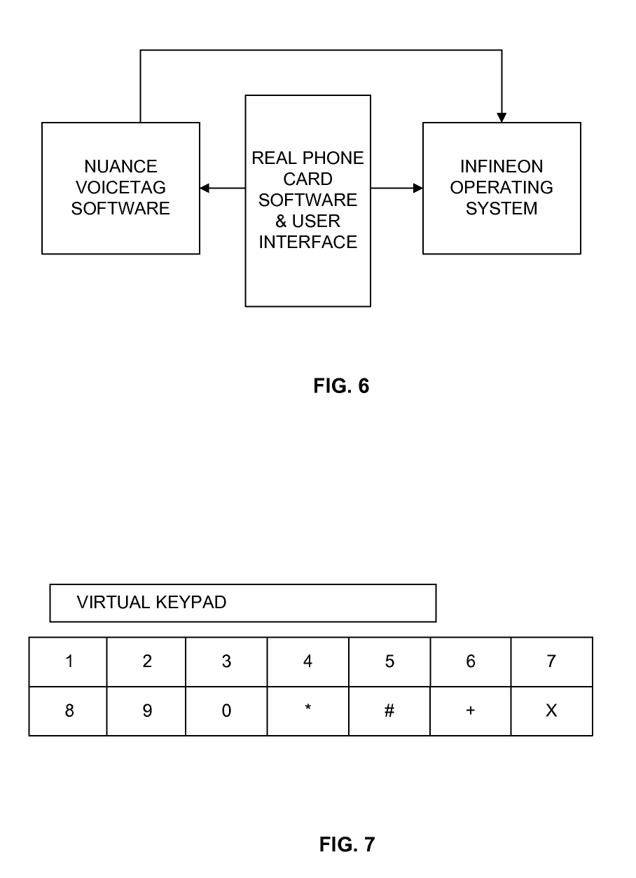

In one embodiment, a VR system includes: an Infineon chipset Operating System (or other suitable chip and operating system), a 16 bit Nuance VR (VR) platform (or other suitable VR platform); and a middle ware layer of software which allows the VR platform to interact with the operating system. This software is depicted further in FIG. 6.

### Nuance VR Software (Nuance Communications, Inc.):

This commercial VoiceTag software package from Nuance, when ported to the Infineon chipset product, incorporates the ability to process speech and identify frequency patterns and present this data to the Application Software. However, it is noted that other voice recognition modules, software, or packages may be incorporated into various alternative embodiments of the present invention.

### Infineon Chip Set (Infineon Technologies, AG):

This commercial integrated chipset product from Infineon comes with an operating system (full featured 16 bit microprocessor based including: processor, digital signal processor, memory, and electronic interfaces) which may be programmed to manage the data into and out of the Nuance software product; facilitate the management of the cellular RF communications requirements, manage the user MMI (Man Machine Interface), provide power management for battery utilization and charging, and other functions. It is noted that various alternative embodiments of the present invention may employ other compatible integrated chipset products and other operating systems.

Application Software (middleware):

This middleware module, or software, performs several important functions within the mobile phone. For example, in one embodiment, the software initializes and controls the phone in terms of RF protocol and performance in accordance with the GSM network standards. In some embodiments, the software provides structure to the interaction between the user and the operating system, commonly called the ‘Man Machine Interface’ or ‘the user interface’. The middleware may create the screen images for the user interface. In some embodiments, the middleware controls and coordinates the sequence of software execution by the Nuance VR software and the Infineon Operating System in response to user commands.

The mobile handset features user dependent VR modules, or software. In order for this to be effective, the phone must be trained to recognize the user's voice. When the handset is first turned ON by pressing switch 222, screen prompts will appear asking if the user wants to train the phone to recognize his/her voice and a “Yes” or “No” choice presented over the soft keys 202 and 204. If the user presses the soft key under “Yes”, 202, the user receives voice and screen prompts to train the phone to recognize his/her voice commands as explained later. If the user presses the soft key under the option, “No”, the phone will not be trained. However, there are still ways to place calls based on the explanations that follow.

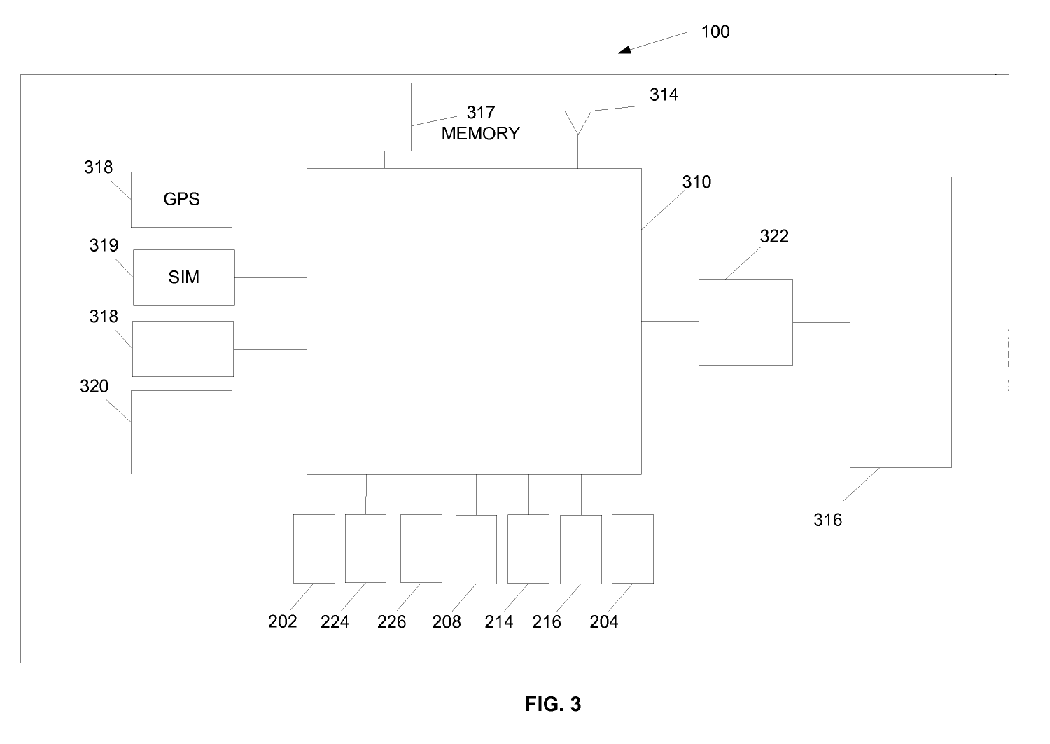

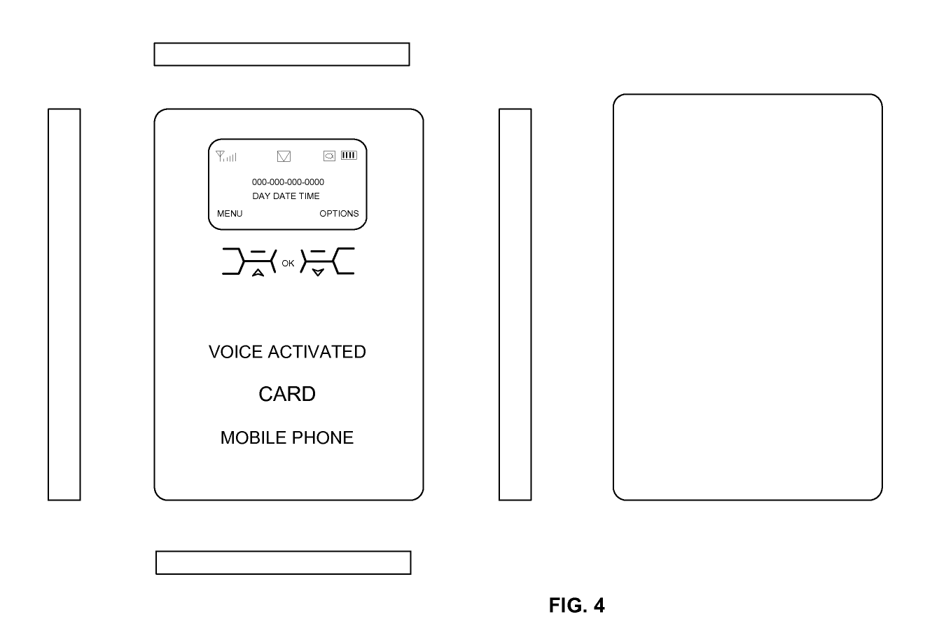

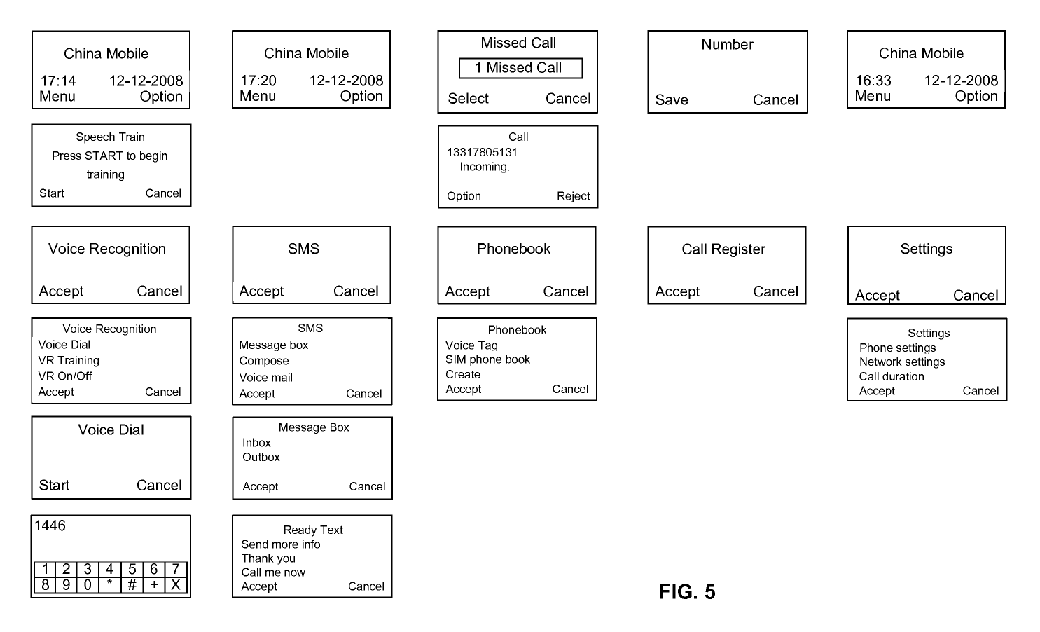

In the example illustrated in FIGS. 2 and 3, the handset body 212 includes a receiver 214, a microphone 216, a display 220 and seven input devices, such as buttons or keys 202, 204, 206, 208, 222, 224, and 226. In one embodiment, two keys are soft keys 202 and 204. In addition, the keys may be watertight and have illumination. One key 222 may be a power button used to turn the phone 100 on and off. The key 226 may be used to initiate a call, answer a call or terminate a call. The keys 206 and 208 are scroll keys used to scroll through the options for the user such as selecting a digit in a dialing sequence with the virtual keypad or selecting an option in a scroll down menu. The OK key 224 may be used to initiate an operation of the handset 100. The use of a limited key set leaves a large area of the front of the handset body available for graphics. For example, a company's logo or advertising can be screen printed or otherwise applied to that area of the handset.

In one embodiment, the display 220 may provide information and status of the handset 100 to a user. For example, the display may provide an indication of the strength of a received signal such as indicated by ascending bars. The display may also provide an indication of a status of the battery, such as indicated by bars in a battery icon. An incoming call notification menu, as described further below, may be indicated by an icon. Likewise, when a voice mail is received, it may be indicated by the presence of an icon. When the handset is in an auto answer menu, as described further below, it may be indicated by a symbol for ‘AUTO ANSWER’, or other type of indication. In addition, a called or calling number may be displayed.

If the user selects a silent menu for ringing, the keypad lights will blink and the incoming number will be displayed in response to an incoming call. This may be useful when the interruption of a cell phone ring is undesirable, yet the user wants to know he/she has an incoming call.

FIGS. 2 and 3 diagram an example embodiment of a cellular or wireless handset 100. The handset 100 includes a control chip and other chips, referred to as a chipset. The chipset may be a single electronic integrated circuit (IC) or multiple ICs that cooperate to perform electronic functions of the handset 100. For example, the chipset may include circuits that control operation of the phone, provide RF transmit and receive operations, interface with a user, and perform other functions. The chipset may interface and cooperate with a microphone 216 and a receiver 214, which may be separate components or combined into a single unit. The chipset may also include VR software so that the handset may be voice activated. In one embodiment, VR software is ported to a control chip. For example, the VR software may include software, or firmware, or both, that controls operation of the control chip to implement VR functions. In another example, the VR software may include software, or firmware, or both that are installed into memory software and the control chip accesses the memory software to implement VR functions. In still another example, the VR software may include hardware that cooperates with the control chip to implement VR functions.

In accordance with one embodiment, the VR software may be ported to the control chip and used to control operation of the handset 100. For example, the VR software can be used to select a handset number from a set of predetermined handset numbers. In one embodiment, a predetermined handset number may be associated with, for example, a reference number or word, a person's name, such as Bob or Tom, or a location such as home or office, or other word that a user associates with the predetermined number. In another embodiment, the user can dial a handset number by speaking the numbers into the speaker.

Some users may choose not to use their voices in operating a phone. In one embodiment, the handset offers a virtual keypad (see FIG. 7) which is displayed on the display 220 to meet this need and is useful in other situations (such as purchasing more minutes from the cellular provider). The virtual keypad appears under certain circumstances and is a horizontal representation of the digits and symbols with the selected digit highlighted on the display. The scroll keys are used to move about the virtual keypad and the OK key is used to make a selection.

In accordance with an embodiment, to dial with the virtual keypad, the process is as follows:
From the main screen, press the OK key once and the virtual keypad will appear.
Use the scroll keys and the OK key to enter the number to be dialed.
The digits will appear above the virtual keypad for confirmation.
The BACK soft key can be used to make corrections.
When the number has been entered, the last box (X) on the virtual keypad is selected.
The screen changes to show the complete number, and depressing the OK key will dial the number.

The chipset may also interface with a display 220. For example, the display 220 may provide visual information to a user. In one embodiment, the display 220 includes an alphanumeric display, such as described above, or a graphical display.

The chipset also interfaces with a call/answer key 226. As described further below, the call/answer key 226 may be used to initiate and answer calls from the handset 100.

Handset 100 may also include memory software that can be used to control the operation of the chipset. The memory software may also be used for storage of data during operation of the handset 100. In one embodiment, the handset 100 may also include a Subscriber Identity Software (SIM) card, for GSM models only. In other embodiments, the handset may include a connector that will accept a SIM card.

In one embodiment, the chipset provides voice-activated dialing only. Optionally, the chipset may include memory, the memory including rewritable memory software adapted to store at least one handset number. In another embodiment, the chipset provides one button access for at least one handset number and provides voice activated dialing for all other outgoing handset calls. In one embodiment, the chipset provides one button access for at least one number such as 911, a toll free customer service number, a handset operator, or a user-defined handset number. In another embodiment, a set of predetermined numbers can be selected by the user using a key. For example the user could press a key, such as the scroll keys 206 and 208 to cycle from one number to the next through the set of predetermined numbers in the virtual keypad on the screen, in the phonebook, or in the Call Register until a desired number is located. The user may then indicate that they want to call the desired number. For example, the user could then press the Call/Answer key 226.

In one embodiment, the chipset further includes VR software. The VR capability may be used to dial a handset number stored in memory, or the user can speak a sequence of numbers to be dialed. In one embodiment, the chipset includes VR software with at least one language profile for a country in which the handset 100 is to be used. The VR software may be adapted to recognize voice instructions for storing, retrieving and dialing handset numbers.

In one embodiment, the chipset in the handset 100 provides access to a wireless network for incoming and outgoing phone calls. In another embodiment, the chipset provides access to a wireless communication network for outgoing phone calls only.

Following is a description of examples of using the handset illustrated in FIGS. 2 and 3. In a first example, a user may activate the phone by depressing or selecting the power key 222 to turn on the handset 100. The display 220 activates. A check is made to verify that the battery is charged. The handset 100 will then automatically attempt to connect with a carrier or service provider and initiate an activation procedure. If the handset is successful in connecting to the carrier or service provider, then the carrier or service provider will respond with signal and the display will show the service provider and the signal strength, such as signal strength bars. The assigned handset number may be shown on the display. The handset is now ready to send and receive calls.

As noted, the handset includes VR software. The VR software cooperates with the chipset to perform various functions. Some of the functions performed by the VR software and the chipset are described below. For simplicity, the following description uses the phrase VR software to include operations that may be performed by the chipset. In one embodiment, the VR software may be trained. For example, a VR training menu may be entered by pressing the menu key 202. Alternatively or additionally, the training menu may be entered when the device is first powered up. Upon entering the training menu the VR software will take a user through a learning routine to identify the characteristics of the user's voice. For example, the training may include having the user speak various words and phrases, such as, numbers 0-9, commands like yes and no, symbols like star and pound (#), and other keywords like ‘call’, ‘phonebook’ and the like.

In one embodiment, the following steps may be taken to place a call. The user may initiate the process by depressing the power key 222. When the handset indicates it is connected to the service provider, the handset 100 is activated. The user may then press the call/answer key 226. The VR software in the handset 100 will respond with “Please say a command.” If the user says, “Call” the phone will prompt, “Say the number, digits separated by beeps”. The user may then speak each digit after the beep prompt. When the entire number has been entered to the user's satisfaction, he/she presses the Call/Answer key to place the call. The VR software will then respond with “Calling” and the handset will dial the number.

In accordance with another embodiment, the middleware allows for the following way to use the mobile handset:
Depress the SEND key once.
The handset prompts, “Say a command”.
The user says, “PHONEBOOK”.
The handset prompts, “Say the name” (of a party previously entered into the Phonebook)
The user says the “name” of the party to be called.
The handset prompts, “Did you say xxxx (name)?”
The user says ‘Yes’ after the beep or presses the OK key (depending on menu set-up)
The handset dials the number stored in the Phonebook associated with this name.
If the user says, “NO”, the handset will repeat, “Say the name” and the process is repeated until a “YES” response, the user presses the OK key, or terminates the process by momentarily pressing the Power ON/OFF key
   Because the handset uses speaker dependent VR software the results can have more than 90% accuracy rate. This is achieved by first training the phone to the user's voice. This takes into account the user's pronunciation and dialects for only a small number of commands, digits, and symbols, all done in less than 1 minute. Examples of the specific commands, digits, and symbols for training are:
Commands: Yes, No, Call, Phonebook
Digits: 0, 1, 2, 3, 4, 5, 6, 7, 8, 9
Symbols: *, +#

Using such a small set of words increases accuracy, training time is short, and all normal cellular voice and some SMS functions can be supported. Training the handset is also easy. When the phone is powered up for the first time with a valid SIM card, the user is prompted if he/she wants to train. Also, there is a menu selection under the VR screen where training can be started at any time. Audio recorded voice prompts are incorporated at many key steps in the phone menu selection process to guide and facilitate ease of use.

Entries into the phonebook may occur by several means: the process may start by using the Virtual Keypad; the process may begin by retrieving a number from the Call Register or SIM card (GSM only); and the process may begin with the digit dialing process described above. In all cases, the instructions are clear and result in a prompt, “Say the name”. When the user has done so the name is prompted back, “Did you say xxxx (name)”? Confirming this enters that number and tag (name) in the Phonebook register.

In the user training, it is important to determine if the user has provided an adequate voice signal for the phone to record the voice signal pattern for subsequent recognition purposes. The handset has threshold software which detects when it has received an adequate voice signal input. If it has determined it has not, the software triggers a prompt, “Please Repeat”. If the user continues to provide inadequate verbal input, the process is repeated a number of times (set at the factory). If successful, the phone moves on to the next voice input. If unsuccessful, the handset prompts, “Input failed” and the process is terminated. In this way the user has feedback as to the status of the recordings of his/her VR training session.

Selecting the Phonebook menu allows the user to browse the voice tags associated with each number stored. This facilitates deleting numbers no longer required or recalling the name associated with a number that has been forgotten. All numbers in the Phonebook must have a tag (name) associated with them.

When a call is placed, if the call is answered, the user can conduct a conversation. If the party called does not answer, the user can terminate the attempted call by depressing the call/answer 226 key. The user can terminate an existing conversation by depressing the call/answer 226 key or depressing the power 222 key to turn the handset 100 off.

In one embodiment, the following steps may be taken to receive a call. To receive a call, the handset 100 is turned on. In one embodiment, if the handset 100 is in an auto answer on the menu, then the incoming call will be automatically answered after a predetermined period of time, for example, after 5 seconds. Answering the call can be proceeded by an audible tone. In another embodiment, if the handset 100 is in an auto-answer off menu, the incoming call can be indicated by one of the incoming call notification menus that are currently set, selected ring tone or blinking backlight. To answer the call, the user can press the call/answer key 226. To terminate a call, the user can press the call/answer key 226 or press the power key 222 to turn the handset 100 off.

In one embodiment, the menu key 202 may be used to set various operating menus of the handset, as well as setting options and accessing features of the handset 100. As noted above, the menu key 202 may be used to enter a training menu for the VR software. In one embodiment, the menu key 202 may be used to access voice messages. For example, if a voice message is received, an indication, such as a voice mail icon, may be displayed to indicate the presence of the voice mail. When a user sees the voice mail indication, the user can press the menu key 202 and access the Message menu screen. By scrolling through the options, voice and SMS messages can be retrieved. The message may be saved, or deleted, in accordance with the user's selection.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

Various illustrative implementations of the present invention have been described. However, one of ordinary skill in the art will see that additional implementations are also possible and within the scope of the present invention.

Accordingly, the present invention is not limited to only those implementations described above. Those of skill in the art will appreciate that the various illustrative software and method steps described in connection with the above described figures and the implementations disclosed herein may often be implemented as electronic hardware, software, firmware or combinations of the foregoing. To clearly illustrate this interchangeability of hardware and software, various illustrative software and method steps have been described above generally in terms of their functionality. Whether such functionality is implemented as hardware or software depends upon the particular application and design constraints imposed on the overall system. Skilled persons may implement the described functionality in varying ways for each particular application, but such implementation decisions should not be interpreted as causing a departure from the scope of the invention. In addition, the grouping of functions within a software or step is for ease of description. Specific functions may be moved from one software or step to another without departing from the invention.

Moreover, the various illustrative software and method steps described in connection with the implementations disclosed herein may be implemented or performed with a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the implementations disclosed herein can be embodied directly in hardware, in software executed by a processor, or in a combination of the two. Software can reside in RAM memory, flash memory, ROM memory, EPROM memory, EEPROM memory, registers, hard disk, a removable disk, a CD-ROM, or any other form of computer or processor readable media. An exemplary storage medium can be coupled to the processor such that the processor can read information from, and write information to, the storage medium. In the alternative, the storage medium can be integral to the processor. The processor and the storage medium can also reside in an ASIC.

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. For example, while a wireless handset has been described, it should be appreciated that the principles of the invention can be applied to any mobile device including: smartphones, personal digital assistants (PDAs), and other similar devices. Thus, it is to be understood that the description and drawings presented herein represent example implementations of the invention and are therefore representative of the subject matter which is broadly contemplated by the present invention. It is further understood that the scope of the present invention fully encompasses other implementations and that the scope of the present invention is accordingly limited by nothing other than the appended claims.

1. A wireless handset that users simple voice command set, voice prompts, screen prompts and input keys, the handset comprising:
a controller;
a microphone;
a receiver;
a speaker;
a display that provides visual information;
a middleware module configured to communicate with a voice recognition module and an operating system to implement a man machine interface (MMI) and voice recognition (VR) functions;
programmable input keys, which can be configured as appropriate to indicate action choices;
wherein the input keys cooperate with the VR module to activate functions of the handset.

2. The handset of claim 1, wherein the handset provides voice activated dialing for outgoing calls.

3. The handset of claim 1, further comprising:
a memory module configured to store at least one handset number,
wherein the VR module resides in the memory module; and
wherein the input keys access the memory module to implement VR functions.

4. The handset of claim 3, wherein the call and answer key and VR module collectively operate to receive a handset number from a user.

5. The handset of claim 1, wherein the VR module is configured for a language in accordance with where the handset is intended to be used selected by the user.

6. The handset of claim 1, wherein the VR module controls the operation of the controller.

7. The handset of claim 1, wherein the voice recognition module is a speaker dependent voice recognition module that is trained by a learning routine to identify characteristics in the user's voice.

8. The handset of claim 1, wherein the learning routine identifies the user's pronunciation and dialect for a small number of words for controlling the handset.

9. The handset of claim 1, further comprising a menu key for changing a menu selection, and wherein the menu key allows a user to select a number in the phonebook by cycling through a set of predetermined phone numbers.

10. The handset of claim 1, further comprising one or more scroll keys for scrolling through the visual information on the display.

11. A method of using a mobile device having voice recognition (VR) capability and a reduced number of input keys, the method comprising:
selecting an input key configured to operate as a call key;
receiving an audio communication from a VR module prompting a user to say a phone number;
saying a phone number;
receiving an audio communication from the VR module verifying the phone number;
placing a phone call by accepting the phone number verified by the VR module.

12. The method of claim 10, wherein a phone number is selected by a user selecting a menu key, the menu key allowing a user to cycle through a set of predetermined phone numbers.

13. The handset of claim 1, further comprising training the voice recognition module by performing a learning routine to identify characteristics in the user's voice.

14. The handset of claim 1, wherein the learning routine identifies the user's pronunciation and dialect for a small number of words for controlling the handset.
